(19) United States
(12) Patent Application Publication
(10) Pub. No.: US 2025/0240201 A1
(43) Pub. Date: Jul. 24, 2025

(54) SYSTEM AND METHOD OF ASSESSING STATUS OF WIRELESS COMMUNICATION TECHNOLOGY OF A VEHICLE

(71) Applicant: GM Global Technology Operations LLC, Detroit, MI (US)

(72) Inventors: Venkata Naga Siva Vikas Vemuri, Farmington Hills, MI (US); Prakash M. Peranandam, Rochester Hills, MI (US); John Sergakis, Bloomfield Hills, MI (US); Scott Thomas Droste, West Bloomfield, MI (US)

(73) Assignee: GM Global Technology Operations LLC, Detroit, MI (US)

(21) Appl. No.: 18/417,767

(22) Filed: Jan. 19, 2024

(51) Int. Cl. H04L 41/0659

(52) U.S. Cl. CPC H04L 41/0661

(57) ABSTRACT

A computer-implemented method that, when executed by data processing hardware, causes the data processing hardware to perform operations comprising detecting one or more alert events, assessing an impact of the one or more alert events on wireless communication technology of a vehicle, estimating status of the wireless communication technology, evaluating resource management for use of a digital key, and providing a matrix of the wireless communication technology to a mobile device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of assessing status of wireless communication technology, and more particularly, to a system and method of assessing status of wireless communication technology used to access a vehicle with a digital key.

Some vehicles are equipped with systems that provide access to the vehicle via a digital key. The digital key may be arranged in an NFC keycard or stored in a digital wallet of a smartphone, for example. In general, a user may attempt to use the digital key via a mobile device to access the vehicle and can be faced with numerous issues as a result of wireless communication technology damage or interruptions unbeknownst to the user or the mobile device. Thus, the shortcomings of previous solutions are addressed by the principles of the present disclosure.

### SUMMARY

One aspect of the disclosure provides a computer-implemented method that, when executed by data processing hardware, causes the data processing hardware to perform operations. These operations include detecting one or more alert events, assessing an impact of the one or more alert events on wireless communication technology of a vehicle, estimating status of the wireless communication technology, evaluating resource management for use of a digital key, and providing a priority matrix of the wireless communication technology to a mobile device.

Implementations of the disclosure may include one or more of the following optional features. In some examples, the wireless communication technology may include a cellular module, a wireless internet module, a wireless low-energy module, an ultra-wideband module, and a near field communication module. Estimating status of the wireless communication technology may further include conducting a dynamic impact assessment of the wireless communication technology. Estimating status of the wireless communication technology may further include conducting a pre-intel based assessment of the wireless communication technology. Estimating status of the wireless communication technology may further include conducting a repair assessment of the wireless communication technology. Estimating status of the wireless communication technology may further include conducting a replacement assessment of the wireless communication technology. Estimating status of the wireless communication technology may further include conducting a compliance assessment of the wireless communication technology.

Another aspect of the disclosure provides a system including data processing hardware and memory hardware in communication with the data processing hardware, the memory hardware storing instructions that, when executed on the data processing hardware, cause the data processing hardware to perform operations. These operations include detecting one or more alert events, assessing an impact of the one or more alert events on wireless communication technology of a vehicle, estimating status of the wireless communication technology, evaluating resource management for use of a digital key, and providing a priority matrix of the wireless communication technology to a mobile device.

Implementations of this aspect of the disclosure may include one or more of the following features. In some examples, the wireless communication technology may include a cellular module, a wireless internet module, a wireless low-energy module, an ultra-wideband module, and a near field communication module. Estimating status of the wireless communication technology may further include conducting a dynamic impact assessment of the wireless communication technology. Estimating status of the wireless communication technology may further include conducting a pre-intel based assessment of the wireless communication technology. Estimating status of the wireless communication technology may further include conducting a repair assessment of the wireless communication technology. Estimating status of the wireless communication technology may further include conducting a replacement assessment of the wireless communication technology. Estimating status of the wireless communication technology may further include conducting a compliance assessment of the wireless communication technology.

An additional aspect of the disclosure provides a vehicle management system. The vehicle management system includes a communication system including wireless communication technology. The wireless communication technology includes a central processing unit communicatively coupled to a cellular module, wireless internet module, a wireless low-energy module, an ultra-wideband module, and a near field communication module. The communication system further includes data processing hardware and memory hardware in communication with the data processing hardware, the memory hardware storing instructions that, when executed on the data processing hardware, cause the data processing hardware to perform operations. These operations include detecting one or more alert events, assessing an impact of the one or more alert events on wireless communication technology of a vehicle, estimating status of the wireless communication technology, evaluating resource management for use of a digital key, and providing a priority matrix of the wireless communication technology to a mobile device.

Implementations of this aspect of the disclosure may include one or more of the following features. For example, estimating status of the wireless communication technology may further include conducting a dynamic impact assessment of the wireless communication technology. Estimating status of the wireless communication technology may further include conducting a pre-intel based assessment of the wireless communication technology. Estimating status of the wireless communication technology may further include conducting a repair assessment of the wireless communication technology. Estimating status of the wireless communication technology may further include conducting a replacement assessment of the wireless communication technology. Estimating status of the wireless communication technology may further include conducting a compliance assessment of the wireless communication technology.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle environment including a vehicle, a mobile device, and a network according to the principles of the present disclosure;

FIG. 2 is a top view of the vehicle of FIG. 1;

FIG. 3 is a schematic diagram of the vehicle management system of the vehicle of FIG. 1;

FIG. 4 is a schematic diagram of the connectivity spectrum surrounding the vehicle of FIG. 1;

FIG. 5 is a flow diagram showing operations of the vehicle management system of FIG. 3;

FIG. 6 is a flow diagram showing a method of assessing Near Field Communication wireless communication technology; and

FIG. 7 is a flow diagram showing a method of assessing cellular wireless communication technology, wireless internet communication technology, wireless low-energy communication technology, and/or ultra-wideband communication technology.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

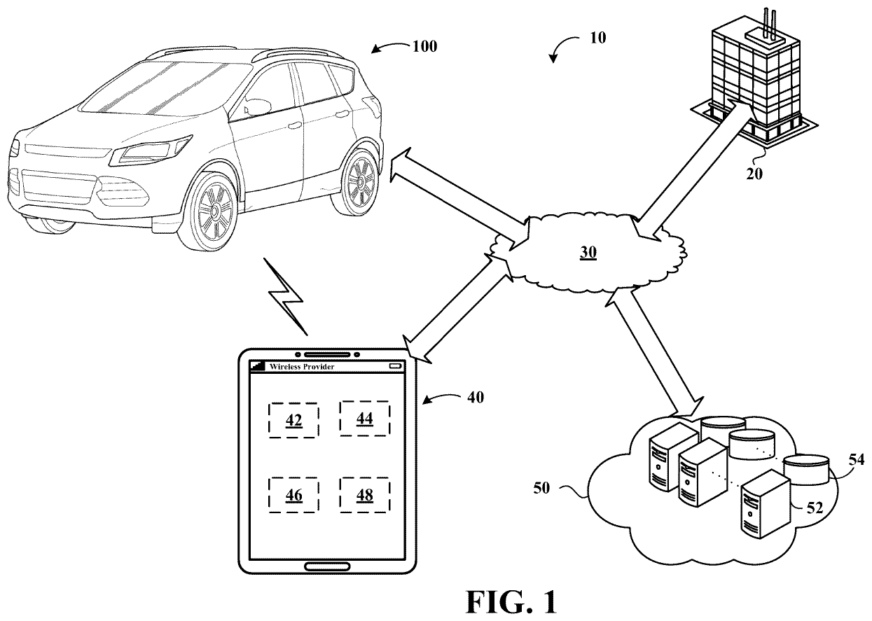

Referring to FIG. 1, an example vehicle operating environment 10 is provided for illustration of the principles of the present disclosure. The vehicle operating environment 10 includes a vehicle 100 and a vehicle monitoring center 20. For the purposes of the present disclosure, the vehicle 100 may include any one of an automobile, an aircraft, a drone, an e-bike, a scooter, or another vehicle that may be accessed with a digital key, for example. For the sake of illustration, the vehicle operating environment 10 is shown including a single vehicle monitoring center 20. However, in other examples, the vehicle operating environment 10 may include a plurality of vehicle monitoring centers 20 in communication with the vehicle 100 over a network 30 (e.g., the Internet, cellular networks). The vehicle monitoring center 20 may include a remote facility or system that receives and monitors diagnostic data and sensor data from the host vehicle 100 to determine one or more vehicle operating conditions. The vehicle operating environment 10 may also include a mobile device 40, which is configured to communicate with the vehicle 100 directly and/or via the network 30, for example.

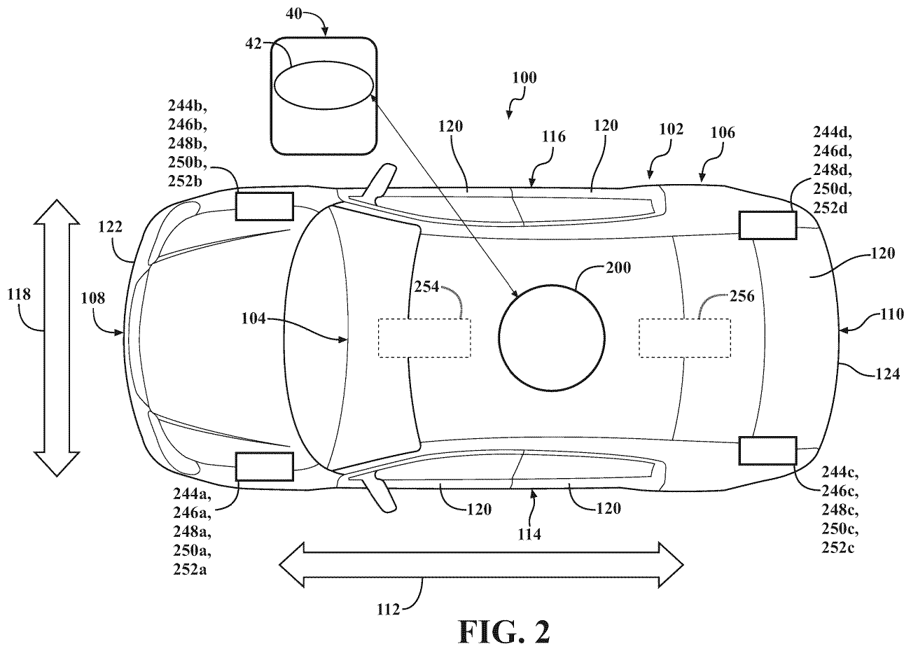

With reference to FIG. 2, the vehicle 100 is shown including a vehicle body 102 that has an interior 104 (i.e., a passenger cabin) and an exterior 106. The vehicle body 102 can include a first or front end 108 and a second or rear end 110 spaced fore-aft from the front end 108 with respect to a longitudinal axis 112. The vehicle 100 can also include a first or left side 114 and a second or right side 116 spaced cross-car from the left side 114 with respect to a lateral axis 118. The vehicle 100 may have one or more closures 120 (i.e., doors, tailgate, etc.) and body features such as a front bumper 122 and a rear bumper 124. The front and rear bumpers 122, 124, as well as other body features, may be made of plastic or another material that does not tend to interfere with the reception and/or transmission of wireless signals across a spectrum of frequencies.

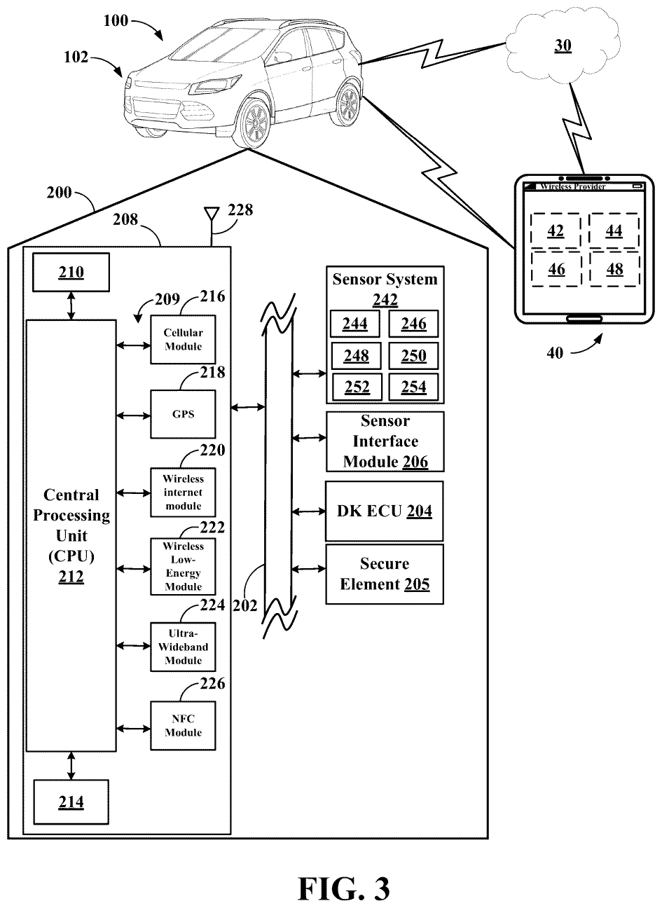

With reference to FIG. 3, the vehicle 100 may be equipped with a vehicle management system 200 (e.g., a telematics unit) that comprises a network connection interface 202. In the present example, the network connection interface 202 is communicatively coupled to the vehicle management system 200. Some examples of the network connection interface 202 may include twisted pair/fiber optic Ethernet switch, internal/external parallel communication bus, a local area network (LAN) interface, a controller area network (CAN), a media-oriented system transfer (MOST), a local interconnection network (LIN) interface, and the like. Other communication interfaces may also include those that conform with ISO, SAE, and IEEE standards and specifications. The network connection interface 202 enables components of the vehicle management system 200 to send and receive signals with each other and with various systems and subsystems both within or “resident” to the vehicle body 102 and outside or “remote” from the vehicle body 102. This allows the vehicle 100 to perform various vehicle functions, such as communicating with the mobile device 40 via peer to peer communication or via the network 30 (i.e., through cellular or wireless internet). The vehicle management system 200 can receive and/or transmit data to/from one or more electronic control units (ECUs) such as a digital key ECU 204 and a sensor interface module 206, for example. The vehicle management system 200 may also communicate with additional ECUs such as an engine control module (ECM), a powertrain control module (PCM), a transmission control module, a brake system control module (BSCM), a climate control module (CCM), etc. The digital key ECU 204 may be configured so that a user or owner of the vehicle 100 can access (i.e., lock, unlock, etc.) the vehicle 100 through a mobile application of the mobile device 40, such as a vehicle original equipment manufacturer application or applet 42 (discussed in more detail below with respect to the mobile device 40). Additionally, the digital key ECU 204 may be configured with a secure element 205 (e.g., NCJ38A Automotive Secure Element), which provides storing and provisioning of credentials in the vehicle 100. The secure element 205 can be communicatively coupled to the digital key ECU 204 over the network connection interface 202, as shown in FIG. 3, for example.

With continued reference to FIG. 3, the vehicle management system 200 can include a communication system 208 (e.g., an onboard computing device) that provides several functions, both individually and through its communication with other networked devices. For instance, the communication system 208 can wirelessly communicate (e.g., via cell towers, base stations, and/or mobile switching centers (MSCs), etc.) with a remotely located or off board cloud computing system 50 (FIG. 1) via the network 30 or with a mobile device 40. The communication system 208 is generally composed of data processing hardware 210, each of which may be embodied as a discrete microprocessor, an application specific integrated circuit (ASIC), or a dedicated control module. The vehicle 100 may offer centralized vehicle control via a central processing unit (CPU) 212 that is operatively coupled to memory hardware 214, each of which may take on the form of a CD-ROM, magnetic disk, IC device, semiconductor memory (e.g., various types of RAM or ROM), etc. The vehicle 100 can include wireless communication technology 209 comprising long-range vehicle communication capabilities and close-range vehicle communication capabilities. The long-range vehicle communication capabilities with remote, off-board networked devices may be provided via one or more or all of a cellular chipset or module 216, a navigation and location chipset or module 218 (e.g., global positioning system (GPS)), or a wireless internet (Wi-Fi®) chipset or module 220. The close-range wireless connectivity may be provided via a close-range wireless communication device such as a wireless low-energy chipset or module 222 (e.g., a Bluetooth® Low Energy (BLE)), an ultra-wideband (UWB) chipset or module 224, and a near field communications (NFC) chipset or module 226, and/or a dual antenna 228.

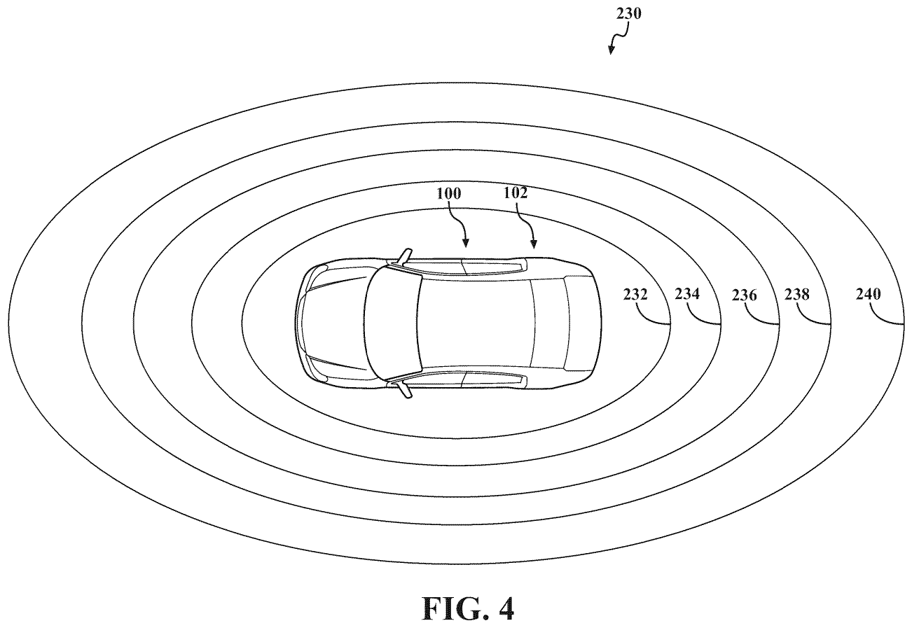

With reference to FIG. 4, the various communication chipset or modules arranged in the communication system 208 can provide a connectivity spectrum 230 surrounding the vehicle 100. For instance, the NFC module 226 may provide close-range communication capabilities with devices (e.g., the mobile device 40) within about a first distance 232 (e.g., about 5 inches or less) of the vehicle 100. The UWB module 224 may provide close-range communication capabilities with devices (e.g., the mobile device 40) within about a second distance 234 (e.g., about 30 meters) of the vehicle 100. The wireless low-energy module 222 may provide close-range communication capabilities with devices (e.g., the mobile device 40) within about a third distance 236 (e.g., about 75 meters) of the vehicle 100. The wireless internet module 220 may provide long-range communication capabilities, via the network 30, with devices (e.g., the mobile device 40) within about a fourth distance 238 (e.g., about 200 meters) of the vehicle 100. The cellular chipset 216 may provide long-range communication capabilities, via the network 30, with devices (e.g., the mobile device 40) within about a fifth distance 240 (e.g., about 600 meters) of the vehicle 100.

The CPU 212 may receive data from one or more sensing devices of a sensor system 242 that are configured for cellular communication, wireless internet communication, low-energy wireless communication, ultra-wideband communication, and/or near-field communication, or for other communication with the network 30 and/or the mobile device 40. In accordance with present disclosure, the vehicle 100 may be equipped with one or more sensors for each wireless communication technology 209. The one or more sensors may be arranged on or within the vehicle 100 and configured to receive wireless communication signals of cellular communication, wireless internet communication, low-energy wireless communication, ultra-wideband communication, and/or near-field communication, for example. In the present example, each wireless communication technology 209 can include four sensors arranged at the corners (i.e., front left, front right, rear left, and rear right) of the vehicle 100. For instance, left and right front cellular sensors 244a, 244b may be arranged on left and right portions of the front bumper 122 and left and right rear cellular sensors 244c, 244d may be arranged on left and right portions of the rear bumper 124. Left and right front wireless internet sensors 246a, 246b may be arranged on left and right portions of the front bumper 122 and left and right rear wireless internet sensors 246c, 246d may be arranged on left and right portions of the rear bumper 124. Left and right front low-energy sensors 248a, 248b may be arranged on left and right portions of the front bumper 122 and left and right rear low-energy sensors 248c, 248d may be arranged on left and right portions of the rear bumper 124. Left and right front UWB sensors 250a, 250b may be arranged on left and right portions of the front bumper 122 and left and right rear UWB sensors 250c, 250d may be arranged on left and right portions of the rear bumper 124. Left and right front NFC sensors 252a, 252b may be arranged on left and right portions of the front bumper 122 and left and right rear NFC sensors 252c,252d may be arranged on left and right portions of the rear bumper 124. Additionally, a first interior sensor 254 may be arranged in a portion of the interior 104 of the vehicle 100, such as in a portion of an upper headliner in the vehicle 100. A second interior sensor 256 may be arranged in a portion of the interior 104 of the vehicle 100, such as in a portion of a center console of the vehicle 100. Receiving data at the CPU 212 from the one or more vehicle key sensors 244-256 may be desirable so that the vehicle 100 can communicate with the mobile device 40 and/or an NFC keycard and provide a variety of communication pathways so that a user may gain access to the vehicle 100 through use of a digital key, for example.

The mobile device 40 (e.g., a smartphone) may be configured to communicate with the wireless communication technology 209 directly or via the network 30, and more specifically, communicate with one or more of the cellular module 216, the navigation and location module 218, the wireless internet module 220, the wireless low-energy module 222, the UWB module 224, and/or the NFC module 226. The mobile device 40 can be equipped with a digital key applet 42, an NFC controller 44, and a mobile secure element 46. The mobile secure element 46 provides storing and provisioning of credentials in the mobile device 40. A digital key 48 may be stored in a digital wallet such as Apple® wallet or Google® wallet, for example.

Until now, the mobile device 40 would communicate with the vehicle 100 with no intelligence (i.e., data) as to the status of the wireless communication technology 209 necessary for utilizing the digital key 48 to access the vehicle 100. In other words, the mobile device 40 would blindly attempt to use the digital key 48 to access the vehicle 100 by using transport and wireless communication technology such as a fixed technology access schema like Bluetooth® Received Signal Strength Indicator, UWB Ranging, and/or BLE Transport before knowing the status of the hardware or software associated with any one of the these technologies. However, there are many vehicular scenarios or events (hereinafter, “alert events”) that can impact the status of the wireless communication technology 209 of the vehicle 100 and several blind attempts (i.e., retries) typically result in poor quality of experience for any user trying to access the vehicle 100. One or more alert events may result in high latency and/or inefficient proximity range too, for example. A first alert event may include a dynamic impact alert event, such as an accident, which can affect one or more of the sensors, antennas, power supply, directivity of the hardware, a software bind, etc. A second alert event may include a pre-intel alert event, such as an ECU over-the-air (OTA) update, which can affect time, ECU features, a duty cycle, etc. A third alert event may include a repair alert event where an original equipment manufacturer (OEM) part was repaired and is not functioning to specification or as previously benchmarked. A fourth alert event may include a replacement alert event where an OEM part was replaced with a non-OEM part and is not functioning to specification of the OEM part. A fifth alert event may include a compliance alert event, such as a regulatory or warranty issue, which can affect use of some wireless communication technology depending on the region in which the vehicle 100 is operating, for example. Other alert events are possible that may affect the status of one or more aspects of the wireless communication technology 209 of the vehicle 100.

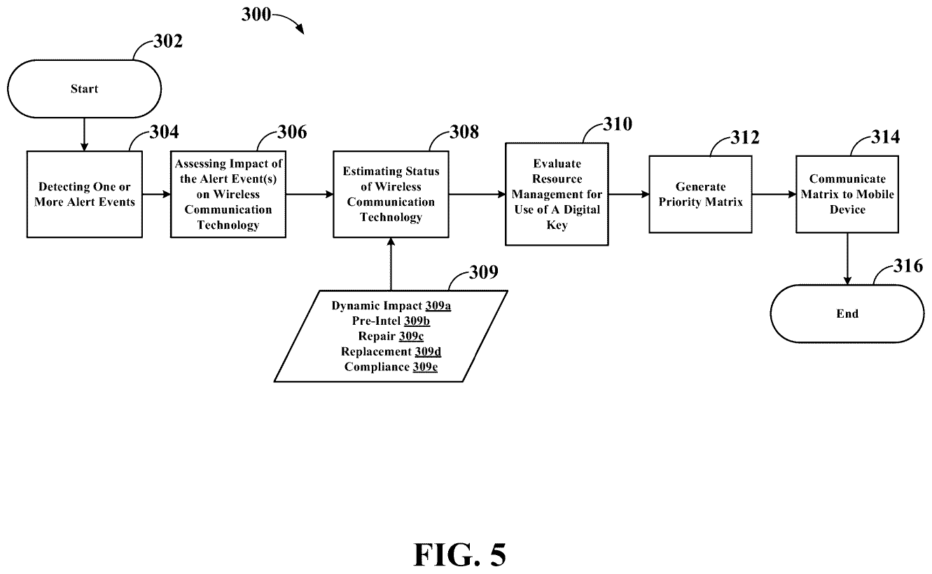

According to the principles of the present disclosure, a method 300 is provided and in general, assesses a status of the wireless communication technology 209 (i.e., hardware and software) available at the vehicle 100, prioritizes the wireless communication technology 209 based on the status and one or more constraints, and communicates the priority of the wireless communication technology 209 to the mobile device 40 before initiation or an attempt to use the digital key 48 to access the vehicle 100. In practical terms, the method 300 can be referenced to as a dynamic reprioritization of the wireless communication technology 209 that may be desirable for retry mechanisms and desirable to accelerate ranging and connection processes for using the digital key 48 with the vehicle 100. The method 300 may be applied in non-vehicle settings as well. For example, the method 300 may also be carried out for the use of digital keys with a home security system (e.g., door locks), computer access, locker access, and in other settings which rely on the use of a digital key to gain access to a system similar to that of the vehicle 100. The method 300 will be discussed in greater detail below with reference to FIG. 5.

At 302, the method 300 is initiated. In practical terms, the method 300 is initiated so long as the vehicle 100 is in at least a low power mode (e.g., Extended Discontinuous Reception (eDRX) or Power Saving Mode (PSM)). In other words, even if the vehicle 100 has been sitting at rest for an extended period of time and is in a low power mode, the method 300 can still be carried out.

At 304, the vehicle 100 can detect at least one of the one or more alert events introduced above. The alert events may be commonly associated with events that cause a status change of at least some of the wireless communication technology 209 of the vehicle 100.

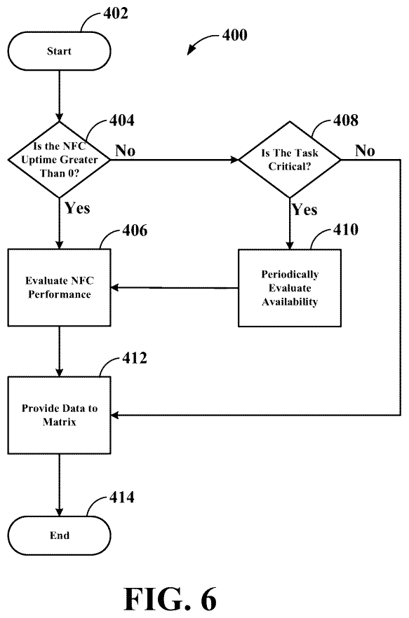

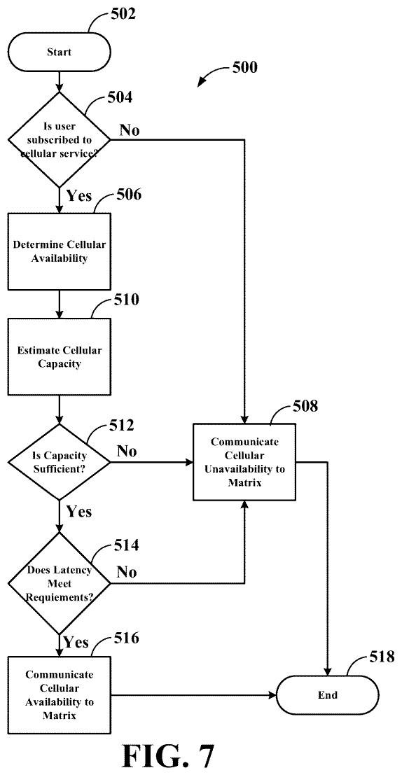

At 306, an impact of the one or more alert events of the wireless communication technology 209 may be assessed using one or more technology state assessments. Examples of technology state assessment methods are provided in FIGS. 6 and 7.

With reference to FIG. 6, a method 400 for assessing a state of NFC wireless communication technology is provided and will be discussed in greater detail below.

At 402, the method 400 is initiated. In practical terms, when at least one of the one or more impact events occurs, the method 400 is initiated and can be carried out.

At 404, the uptime of the NFC module 226 can be evaluated. An uptime that is greater than zero can indicate that the NFC module 226 is operating and available for use. Thus, the method 400 can proceed to 406. On the other hand, an uptime of zero indicates that the NFC module is not working properly and the method 400 can proceed to 408.

At 408, the desired task may be critical (e.g., an energy mission, etc.) and thus periodic evaluation of availability of the NFC module 226 at 410 may be necessary. Once the NFC module 226 is available, the method 400 will proceed to 406. On the other hand, if the desired task is not critical, then the method 400 may proceed to 412 where the data is provided to a matrix for further evaluation.

At 406, the performance of the NFC module 226 can be evaluated. Some metrics that may be assessed include near field signal strength, Rayleigh distance, latency, grid alignment and size, NF beam split, and spatial effect. Additional metrics may be evaluated as well. The data resulting from this evaluation may be provided to the matrix at 412 for further evaluation, which will be discussed below.

At 414, the method 400 ends.

With reference to FIG. 7 a method 500 for assessing a state of a cellular wireless communication technology, wireless internet communication technology, wireless low-energy communication technology, and/or ultra-wideband communication technology is provided and will be discussed in more detail below.

At 502, the method 500 is initiated. In practical terms, when at least one of the one or more impact events occurs, the method 500 is initiated and can be carried out. The method 500 is shown for evaluating a cellular communication module but can be similarly applied to other wireless communication technology as well.

At 504, it is first determined whether a user of the vehicle is subscribed to cellular service. If no subscription is found, the method 500 will continue to 508 where such information will be provided to the matrix for further evaluation. On the other hand, if a subscription is found then the method will continue to 506.

At 506, cellular availability will be determined. According to at least one aspect, this may include determining whether service is enabled, available, and or unavailable.

At 510, cellular capacity may be evaluated and estimated. For instance, cell signal strength, quality, and/or bandwidth may be determined. Additionally, carrier aggregation bandwidth may be estimated as well as multiple input multiple output (MIMO) performance based on antenna status and cell measurements, for example.

At 512, the cellular capacity is evaluated and determined whether it is sufficient. If it is not sufficient, the method 500 continues to step 508 where cellular unavailability is communicated to the matrix for further evaluation. If cellular capacity is sufficient, then the method 500 continues to 514.

At 514, latency (e.g., first hop latency) is estimated and it is determined whether it is sufficient to meet the requirements. If the latency requirements are met, then the method proceeds to step 516 where cellular availability is communicated to the matrix for further evaluation. If the latency requirements are not met, then the method 500 proceeds to step 508 where cellular unavailability is communicated to the matrix for further evaluation.

After steps 508 or 516, the method 500 ends at 518.

Returning to method 300, at 308, the status (i.e., the availability and performance) of the wireless communication technology can be estimated using one or more constraint-based technology assessments. The one more constraint-based technology assessments 309 may include a dynamic impact assessment 309a, a pre-intel based assessment 309b, a repair and/or replacement assessment 309c, 309d, and/or a compliance assessment 309e. Each of these constraint-based technology assessments 309a-309e may be individually or simultaneously carried out for each sensor 244-252 arranged near the front left, front right, rear left, and rear right of the vehicle 100. For example, with respect to the front right sensors 244b, 246b, 248b, 250b, 252b, the dynamic impact assessment 309a can be used to determine the impact of one or more of the alert events. Thus, if the vehicle 100 was in an accident (e.g., backed into in a parking lot) the dynamic impact assessment 309a can evaluate the front right sensors 244b, 246b, 248b, 250b, 252b for the wireless technology 209 and determine whether one or more of the front right sensors 244b, 246b, 248b, 250b, 252b is damaged and currently unavailable for use. The dynamic impact assessment 309a can be carried out on the front left sensors 244a, 246a, 248a, 250a, 252a, the rear left sensors 244c, 246c, 248c, 250c, 252c, and the rear right sensors 244d, 246d, 248d, 250d, 252d as well. Data gathered from the dynamic impact assessment 309a that concerns the status (i.e., availability and performance) of the wireless technology 209 may be desirable to help determine an optimal wireless communication technology 209 to utilize in the event a user tries to use the digital key 48 to access the vehicle 100.

In a similar fashion, the pre-intel based assessment 309b may be used to assess the front left sensors 244a, 246a, 248a, 250a, 252a, the front right sensors 244b, 246b, 248b, 250b, 252b, the rear left sensors 244c, 246c, 248c, 250c, 252c, and the rear right sensors 244d, 246d, 248d, 250d, 252d. The pre-intel based assessment 309b can determine whether the digital key ECU 204 is temporarily unavailable (e.g., due to an OTA update), for example. According to at least one aspect of the present disclosure, if a user tries to use the digital key 48 to access the vehicle 100 while the digital key ECU 204 is unavailable, another wireless communication technology may be prioritized for ranging and transport. This may be desirable to alleviate any connectivity issues that would normally occur without such reprioritization of wireless communication technology 209.

The repair assessment 309c and/or replacement assessment 309d may be used to assess the front left sensors 244a, 246a, 248a, 250a, 252a, the front right sensors 244b, 246b, 248b, 250b, 252b, the rear left sensors 244c, 246c, 248c, 250c, 252c, and the rear right sensors 244d, 246d, 248d, 250d, 252d. The repair assessment 309c can be used to determine whether one of the sensors was incorrectly located on the vehicle 100 after being repaired or whether the performance of the repaired sensor has degraded when compared to acceptable specifications of a fully operable sensor, for example. In the event a sensor of the vehicle 100 is replaced with an OEM or non-OEM part, the replacement assessment 309d can be used to determine whether performance of the replacement sensor continues to meet the specifications of the sensor originally installed on the vehicle 100. In some instances, non-OEM replacement parts do not meet the specifications of the OEM designed parts, which can affect the use of one or more features of the vehicle 100, such as using the digital key 48 to access the vehicle 100. The compliance assessment 309e may be used to assess the front left sensors 244a, 246a, 248a, 250a, 252a, the front right sensors 244b, 246b, 248b, 250b, 252b, the rear left sensors 244c, 246c, 248c, 250c, 252c, and the rear right sensors 244d, 246d, 248d, 250d, 252d. The compliance assessment 309e may be carried out on the sensors arranged on just the left side 114 or just the right side 116 of the vehicle 100 as well. The compliance assessment 309e may be used to determine whether the sensors are functioning such that they comply with regulatory and/or warranty standards, for example. Some countries or regions of the world have implemented requirements and/or restrictions on the use of wireless communication technology 209 and, thus, the compliance assessment 309e may be used to determine whether the sensors of the vehicle 100 are functioning (i.e., hardware and software) accordingly.

At 310, resource management of the wireless communication technology 209 may be evaluated. For instance, other systems of the vehicle 100 (e.g., a battery management system and tire pressure management system) may be utilizing some of the wireless communication technology 209 (e.g., UWB). As a result of one or more of the alert events, one or more of the sensors (e.g., a UWB sensor) may have been impacted so as to degrade the functionality of one of the wireless communication technologies 209 (e.g., UWB). Thus, as a result of the impact to the sensor and the use of the wireless communication technology 209 (e.g., UWB) by other vehicle systems, that particular wireless communication technology 209 (e.g., UWB) may not be desirable to use in the event a user attempts to access the vehicle 100 using the digital key 48.

At 314, a priority matrix for the wireless communication technology may be generated. Data is gathered above from the tech assessment and impact constraint-based assessment and the following priority matrix considering availability, software capacity, hardware capacity, utilization, and latency is generated. An example of a solved output matrix that may be sent to the mobile device 40 is provided below in Table 1.

TABLE 1
Solved Output Matrix

| Wireless | Hardware | Software | |
|---|---|---|---|
| Communication | (Status | (Status | |
| Technology | Feedback) | Feedback) | Ranking |
| NFC | Y1% (Yellow) | Z1% (Red) | 3 |
| Cellular | Z2% (Red) | Z2% (Red) | 4 |
| UWB | X1% (Green) | Y1% (Yellow) | 2 |
| BLE | X2% (Green) | X1% (Green) | 1 |

Based on status feedback of hardware and software, low-energy wireless communication technology (e.g., BLE) is the most desirable form of wireless communication technology available on the vehicle 100. Thus, according to this example, it should be utilized in the event a user attempts to use the digital key 48 to access the vehicle. As shown in the table, wireless internet is not prioritized as a wireless communication technology on the output matrix. Wireless internet can be a costly (i.e., require a lot of energy) form of wireless communication technology 209 so it can be weighted and prioritized accordingly. On the other hand, low-energy wireless, such as BLE, has low cost (i.e., requires low energy) so it can also be weighted and prioritized accordingly.

At 316, the method 300 is terminated.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method that, when executed by data processing hardware, causes the data processing hardware to perform operations comprising:
detecting one or more alert events;
assessing an impact of the one or more alert events on wireless communication technology of a vehicle;
estimating status of the wireless communication technology;
evaluating resource management for use of a digital key; and
providing a matrix of the wireless communication technology to a mobile device.

2. The method of claim 1, wherein the wireless communication technology comprises a cellular module, a wireless internet module, a wireless low-energy module, an ultra-wideband module, and a near field communication module.

3. The method of claim 1, wherein estimating status of the wireless communication technology further comprises conducting a dynamic impact assessment of the wireless communication technology.

4. The method of claim 3, wherein estimating status of the wireless communication technology further comprises conducting a pre-intel based assessment of the wireless communication technology.

5. The method of claim 4, estimating status of the wireless communication technology further comprises conducting a repair assessment of the wireless communication technology.

6. The method of claim 5, wherein estimating status of the wireless communication technology further comprises conducting a replacement assessment of the wireless communication technology.

7. The method of claim 6, wherein estimating status of the wireless communication technology further comprises conducting a compliance assessment of the wireless communication technology.

8. A system comprising:
data processing hardware; and
memory hardware in communication with the data processing hardware, the memory hardware storing instructions that, when executed on the data processing hardware, cause the data processing hardware to perform operations comprising:
detecting one or more alert events;
assessing an impact of the one or more alert events on wireless communication technology of a vehicle;
estimating status of the wireless communication technology;
evaluating resource management for use of a digital key; and
providing a matrix of the wireless communication technology to a mobile device.

9. The system of claim 8, wherein the wireless communication technology comprises a cellular module, a wireless internet module, a wireless low-energy module, an ultra-wideband module, and a near field communication module.

10. The system of claim 8, wherein estimating status of the wireless communication technology further comprises conducting a dynamic impact assessment of the wireless communication technology.

11. The system of claim 10, wherein estimating status of the wireless communication technology further comprises conducting a pre-intel based assessment of the wireless communication technology.

12. The system of claim 11, estimating status of the wireless communication technology further comprises conducting a repair assessment of the wireless communication technology.

13. The system of claim 12, wherein estimating status of the wireless communication technology further comprises conducting a replacement assessment of the wireless communication technology.

14. The system of claim 13, wherein estimating status of the wireless communication technology further comprises conducting a compliance assessment of the wireless communication technology.

15. A vehicle management system comprising:
a communication system including wireless communication technology comprising:
a central processing unit communicatively coupled to:
a cellular module,
a wireless internet module,
a wireless low-energy module,
an ultra-wideband module, and
a near field communication module;
data processing hardware; and
memory hardware in communication with the data processing hardware, the memory hardware storing instructions that, when executed on the data processing hardware, cause the data processing hardware to perform operations comprising:
detecting one or more alert events;
assessing an impact of the one or more alert events on wireless communication technology of a vehicle;
estimating status of the wireless communication technology;
evaluating resource management for use of a digital key; and
providing a matrix of the wireless communication technology to a mobile device.

16. The vehicle management system of claim 15, wherein estimating status of the wireless communication technology further comprises conducting a dynamic impact assessment of the wireless communication technology.

17. The vehicle management system of claim 16, wherein estimating status of the wireless communication technology further comprises conducting a pre-intel based assessment of the wireless communication technology.

18. The vehicle management system of claim 17, estimating status of the wireless communication technology further comprises conducting a repair assessment of the wireless communication technology.

19. The vehicle management system of claim 18, wherein estimating status of the wireless communication technology further comprises conducting a replacement assessment of the wireless communication technology.

20. The vehicle management system of claim 19, wherein estimating status of the wireless communication technology further comprises conducting a compliance assessment of the wireless communication technology.
